(19) United States
(12) Patent Application Publication
(10) Pub. No.: US 2015/0239716 A1
(43) Pub. Date: Aug. 27, 2015

(54) METHOD FOR SIGNALING THE DANGER OF A CRANE TIPPING

(71) Applicant: Palfinger AG, Salzburg (AT)

(72) Inventors: Walter HABERL, Nussdorf (AT); Alexander SCHALBER, Anif (AT)

(21) Appl. No.: 14/708,663

(22) Filed: May 11, 2015

Related U.S. Application Data
(63) Continuation of application No. PCT/AT2013/000187, filed on Nov. 8, 2013.

(30) Foreign Application Priority Data
Nov. 12, 2012 (AT) 1199/2012

(51) Int. Cl. B66C 23/88; B66C 15/06

(52) U.S. Cl. CPC B66C 23/88; B66C 15/06

(57) ABSTRACT

The invention relates to a method for signaling the danger of a crane tipping, comprising at least three alarm systems for signaling tipping warnings using a respective safety programme. At least one measurement value is obtained from the crane, at least two alarm systems for signaling the tipping warning are selected in accordance with the at least one measurement value and if a warning of tipping is signaled by at least two of the at least two selected alarm signals, a tipping warning is signalled.

The present invention concerns a method of signalling the danger of a crane tipping having the features of the classifying portion of claim 1, a safety device for a crane having the features of the classifying portion of claim 13 and a crane having such a safety device.

Various methods are known, which are intended to guarantee the stability of a mobile crane. Thus EP 1 925 585 A1 and EP 2 113 481 A1 disclose methods which carry out calculations relating to the stability of the crane purely on the basis of the position of the crane jib and the positions of the support extensions of the support legs. By definition the position of the crane jib includes the entire kinematics of the crane jib together with the pivot angle. The results of those calculations can then be used to limit the movements of the crane if, in accordance with the calculations, the crane threatens to tip.

DE 199 83 149 T1 discloses a method in which the inclination of the crane—in particular the crane base—is measured and movements which increase the tipping moment are prevented when an inclination limit value is exceeded.

EP 1 772 333 B1 and EP 2 298 689 A2 disclose methods relating to cranes which have support legs. Such support legs can be in the form of hydraulic supports. In those methods the forces in the support legs are measured and used as a basis for calculation of the maximum permissible tipping moment of the crane.

None of those methods is optimum in every operating situation as for example in dependence on the position of the crane jib, a carrier vehicle of the crane can involve differing stiffness or elasticity, also by virtue of a different loading on the carrier vehicle. Thus, in the case of stability monitoring on the basis of a tipping load calculation or by monitoring the supporting forces, the elasticity of the carrier vehicle is a priori not taken into consideration. In the case of stability monitoring on the basis of monitoring the supporting forces the result of this is that the stability cannot be fully utilised at high levels of flexibility. Here a vehicle can still be stable in spite of individual support legs lifting off.

In comparison, the elasticity of the carrier vehicle is admittedly manifestly taken into consideration in the case of stability monitoring on the basis of inclination. It will be noted however that in situations in which the carrier vehicle has a high degree of stiffness, the inclination resulting from the loading of the crane is relatively slight. Under some circumstances that slight inclination is difficult to detect by the inclination measuring device, or cannot be detected at all. It is further found that, in the event of strongly dynamic working movements, the criterion of inclination can scarcely be referred to for assessing the stability of the carrier vehicle. Therefore in this case the limit values have to be very restrictively selected or the overload system has to be deactivated.

The object of the invention is to fully utilise the stability of the carrier vehicle in every operating situation and for every loading situation of the carrier vehicle.

That object is attained by a method having the features of claim 1, by a safety device for a crane having the features of claim 13 and by a crane having such a safety device.

That is effected by a procedure whereby in dependence on individual parameters of the operating condition of the crane alarm systems or safety programs which are suitable for the instantaneously prevailing elasticity of the carrier vehicle are selected and a tipping danger is signalled when at least two of the selected alarm systems produce a tipping warning.

Further advantageous configurations are defined in the appendant claims.

Various measurement values can be used as the parameters of the operating condition of the crane. They include the position of the crane jib, the positions of the support extensions, the supporting forces in the support legs, the inclination of the crane base and wheel forces in the wheels of the carrier vehicle. In certain situations it is also conceivable to use the inclination of the crane foot before beginning work for that selection.

One of the alarm systems can be of such a configuration that a calculation of a tipping moment and a stand moment of the crane is performed in dependence on the position of at least one crane jib of the crane. Utilising those values, a maximum permissible limit value for the stroke cylinder force can be determined and a tipping warning can be signalled when that limit value is exceeded. In that case a previously measured elasticity of the carrier vehicle, or a carrier vehicle elasticity which has been previously determined in some other fashion, can be incorporated into the calculation of the maximum permissible stroke cylinder force.

The inclination of the crane base can be measured in relation to one of the alarm systems for signalling tipping warnings. When an inclination limit value is exceeded by the inclination a tipping warning can then be signalled. That inclination limit value can be selected in dependence on the position of the crane arm and/or the position of the support legs of the crane.

In the case of one of the alarm systems for signalling tipping warnings the supporting forces in the support legs of the crane and/or wheel forces in the wheels of the carrier vehicle can be measured.

It can also be provided that the tipping danger is signalled only in the event of the existence of signals of tipping warnings by more than two or all selected alarm systems.

It is preferably provided that movements of the crane which increase the tipping moment are prohibited when there is the warning of the tipping danger.

Protection is also claimed for a safety device for a crane having a memory means in which at least three safety programs for signalling tipping warnings can be stored, and at least one measuring device for measuring at least one measurement value, characterised in that at least two safety programs for signalling tipping warnings can be selected by the safety device in dependence on the at least one measurement value and that when there exist at least two signallings of tipping warnings by the at least two selected safety programs signalling of the tipping danger can be sent by the safety device.

Protection is further claimed for a crane having such a safety device.

1. A method of signalling the danger of a crane tipping, which has at least three alarm systems for signalling tipping warnings using a respective safety program, wherein at least one measurement value is obtained on the crane, wherein
at least two alarm systems for signalling tipping warnings are selected in dependence on the at least one measurement value, and
when there are signallings of tipping warnings from at least two of the at least two selected alarm systems the tipping danger is signalled.

2. A method as set forth in claim 1 for signalling the danger of a crane tipping, which has at least one crane jib, wherein the position of the crane jib is measured as one of the measurement values.

3. A method as set forth in claim 1 for signalling the danger of a crane tipping, which has at least one support leg, wherein at least one position of at least one support extension of the at least one support leg is measured as one of the measurement values.

4. A method as set forth in claim 1 for signalling the danger of a crane tipping, which has at least one support leg, wherein the supporting force in the at least one support leg is measured as one of the measurement values.

5. A method as set forth in claim 1 for signalling the danger of a crane tipping, which has a crane base, wherein an inclination of the crane base is measured as one of the measurement values.

6. A method as set forth in claim 1 for signalling the danger of a crane tipping, which has at least one crane jib having at least one stroke cylinder, wherein in relation to at least one of the alarm systems for signalling tipping warnings in dependence on the position of the at least one movable crane jib a calculation of a tipping moment and a stand moment of the crane is performed and a maximum permissible limit value is determined therefrom for a stroke cylinder force in the stroke cylinder and a tipping warning is signalled when said limit value is exceeded.

7. A method as set forth in claim 6, wherein an elasticity of the carrier vehicle of the crane, which has been previously measured or previously determined in some other way is incorporated into the calculation of the limit value for the stroke cylinder force.

8. A method as set forth in claim 1 for signalling the danger of a crane tipping, which has a crane base, wherein in relation to one of the alarm systems for signalling tipping warnings the inclination of the crane base is measured and a tipping warning is signalled when an inclination limit value is exceeded by the inclination.

9. A method as set forth in claim 8 for signalling the danger of a crane tipping, which has at least one crane jib and at least one support leg with a support extension, wherein the inclination limit value is selected in dependence on the position of the crane jib and/or the position of support extensions of the support legs of the crane.

10. A method as set forth in claim 1 for signalling the danger of a crane tipping, which has at least one support leg and which is mounted on a vehicle with wheels, wherein in relation to one of the alarm systems for signalling tipping warnings at least one supporting force in the at least one support leg and/or wheel forces in the wheels are measured.

11. A method as set forth in claim 1, wherein the tipping danger is signalled when there are signallings of tipping warnings by all selected alarm systems.

12. A method as set forth in claim 1, wherein movements of the crane which increase the tipping moment are blocked when there is a signalling of the danger of tipping.

13. A safety device for a crane having a storage means in which at least three safety programs for signalling tipping warnings can be stored, and at least one measuring device for measuring at least one measurement value, wherein at least two safety programs for signalling tipping warnings can be selected by the safety device in dependence on the at least one measurement value and that a signalling of the danger of tipping can be sent by the safety device in the existence of at least two signallings of tipping warnings by the at least two selected safety programs.

14. A crane having a safety device as set forth in claim 13.
